(19) United States
(12) Patent Application Publication
(10) Pub. No.: US 2007/0144028 A1
(43) Pub. Date: Jun. 28, 2007

(54) Clothes dryer with improved air flow

(75) Inventors: Serge Audet, Longueil (CA); Dominique Larochelle, St-Bruno (CA); Tsimi Nkoa, Vaudreuil-Dorion (CA)

Correspondence Address: CRAIG WILSON, 2570 MATHESON BLVD. EAST, SUITE 211, MISSISSAUGA, ON, L4W 4Z3, US

(73) Assignee: MABE CANADA INC., Burlington (CA)

(21) Appl. No.: 11/635,496

(22) Filed: Dec. 8, 2006

(30) Foreign Application Priority Data
Dec. 28, 2005 (CA) 2,531,591

(51) Int. Cl. F26B 21/06; F26B 19/00

(52) U.S. Cl. 34/82; 34/85

(57) ABSTRACT

An appliance for drying clothing articles has a drum for receiving the clothing articles, a motor for rotating the drum about an axis, a heater for supplying heated air to the drum during a drying cycle and a trap duct in air flow communication with the dryer drum through which air flows when leaving the dryer drum. The trap duct comprises a filter for trapping lint, and an air flow baffle positioned downstream of the lint filter that extends parallel to direction of air flow through the trap duct to improve air flow in the dryer.

### FIELD OF THE INVENTION

The present invention relates to an appliance for drying clothing articles, and, more particularly, to a baffle positioned in the trap duct for improving air flow through a clothes dryer.

### BACKGROUND OF THE INVENTION

In present clothes drying appliances, it is known to provide a trap duct that houses a removable filter. The trap duct provides an air flow passageway between the dryer drum and the exhaust passageway for the dryer. The removable filter collects lint in the air flow passing through the trap duct. However lint has a tendency to pass through the filter and collect in the trap duct downstream of the filter. The collection of lint in the trap duct downstream of the filter is more of problematic for low air flow conditions resulting from increased restrictions at the exhaust for the clothes dryer.

### BRIEF DESCRIPTION OF THE INVENTION

The present invention relates to an appliance for drying clothing articles wherein the appliance comprises a drum for receiving the clothing articles, a motor for rotating the drum about an axis, a heater for supplying heated air to the drum during a drying cycle and a trap duct in air flow communication with the dryer drum through which air flows when leaving the dryer drum. The trap duct comprises a filter for trapping lint, and an air flow baffle positioned downstream of the lint filter that extends parallel to direction of air flow through the trap duct.

By employing a baffle located downstream of the lint filter, the baffle acts to divert a portion of the air flow towards an exit opening of the trap duct. This reduces the collection of lint in the trap duct downstream from the filter. By having a baffle extend in a direction parallel to direction and air flow in the trap duct there is less of a tendency for lint to collect on the baffle surfaces. Further, by having a baffle extend parallel to air flow, the baffle presents minimal resistance to the air flow in the trap duct.

### BRIEF DESCRIPTION OF THE DRAWINGS

For a better understanding of the nature of the present invention reference may be made by way of example to the accompanying diagrammatic drawings.

FIG. 1 is a perspective view of an exemplary clothes dryer that may benefit from the present invention;

FIG. 2 is a side sectional view of an exemplary clothes dryer that may benefit from the present invention; and,

FIG. 3 is a front partial perspective view showing the trap duct of the present invention.

### DETAILED DESCRIPTION OF THE INVENTION

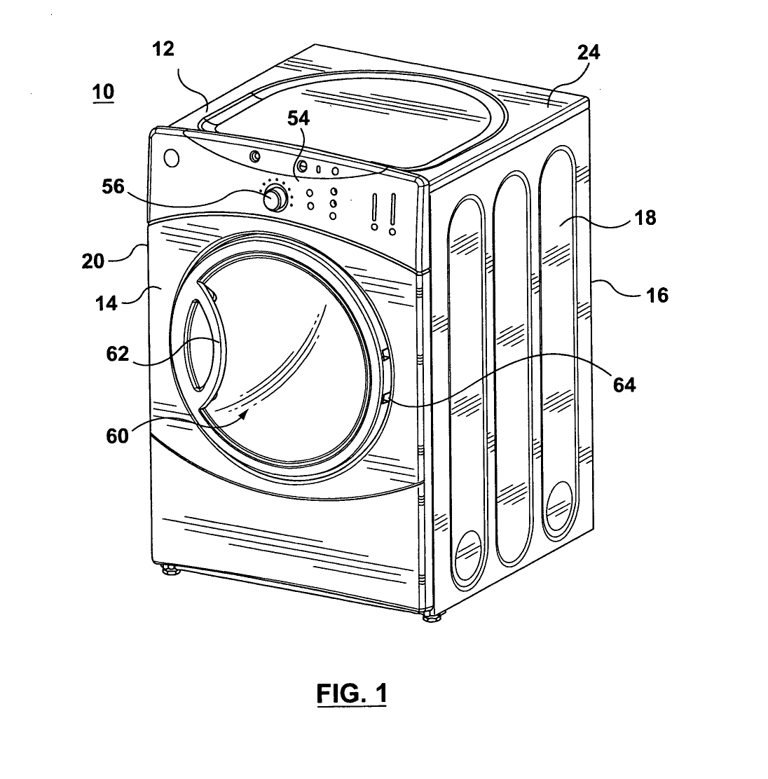

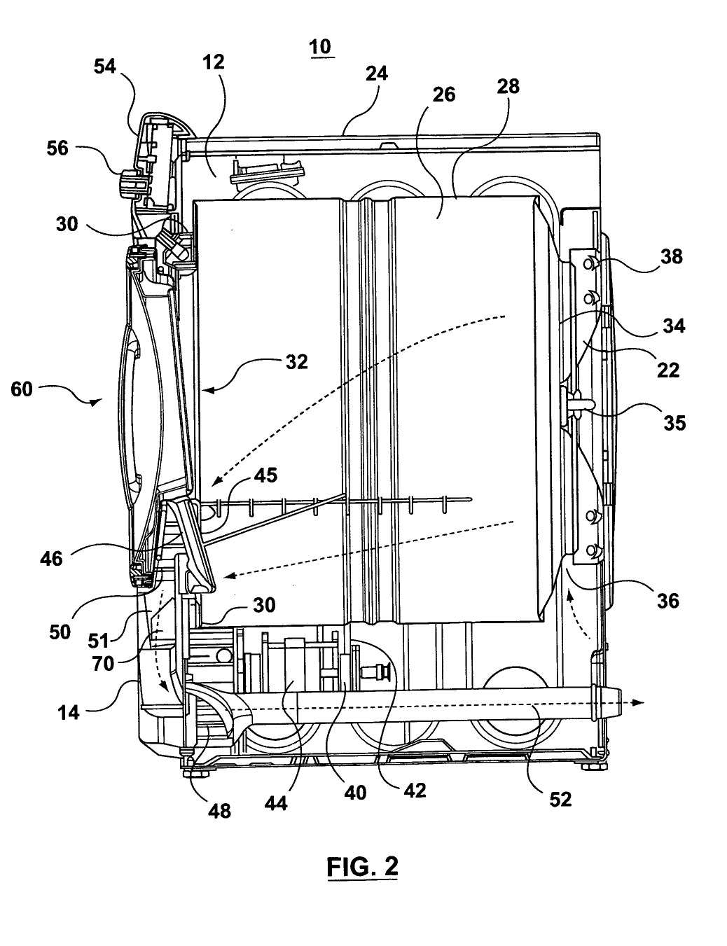

FIGS. 1 and 2 show perspective and side sectional views of an exemplary clothes dryer 10 that may benefit from the present invention. The clothes dryer includes a cabinet or a main housing 12 having a front panel 14, a rear panel 16, a pair of side panels 18 and 20 spaced apart from each other by the front and rear panels, and a top cover 24. Within the housing 12 is a drum or container 26 mounted for rotation around a substantially horizontal axis. A motor 44 rotates the drum 26 about the horizontal axis through, for example, a pulley 40 and a belt 42. The drum 26 is generally cylindrical in shape, has an imperforate outer cylindrical wall 28, and is closed at its front by a bulkhead wall or bearing 30 defining an opening 32 into the drum 26. Clothing articles and other fabrics are loaded into the drum 26 through the opening 32. A plurality of tumbling ribs (not shown) are provided within the drum 26 to lift the articles and then allow them to tumble back to the bottom of the drum as the drum rotates. The drum 26 includes a rear wall 34 rotatably supported within the main housing 12 by a suitable fixed bearing 35. The rear wall 34 includes a plurality of holes (not shown) that receive hot air that has been heated by a heater such as electrical heating elements 38 in the heater housing 22. The housing 22 receives ambient air via an inlet 36. Although the exemplary clothes dryer 10 shown in FIG. 1 is an electric dryer, it could just as well be a gas dryer having a gas burner.

After the clothing articles have been dried, they are removed from the drum 26 via the opening 32. The dryer has a control panel 54 with touch and or dial controls 56 whereby a user can control the operation of the dryer. Clothes are inserted into, and removed from, the drum 26 through opening 32. Opening 32 is shown closed by a window or port-hole like door 60. Door 60 has a handle 62 for pivotally opening the door about hinge 64.

Heated air is drawn from the drum 26 by a blower fan 48 which is also driven by the motor 44 in the embodiment shown. The air passes through a grill 45 and screen filter 46. Grill 45 keeps clothing articles tumbling in the drum 26 from contacting the filter 46 and touching the lint trapped by the filter 46 within the trap duct 50. As the air passes through the screen filter 46, it flows through lower duct portion 51 and is drawn by blower wheel 48 attached to motor 44 out of the clothes dryer through an exhaust duct 52. In this embodiment, the drum 26 is in air flow communication with the trap duct 50 whose lower duct portion 51 has an outlet that is in air flow communication with the blower wheel 48 and the exhaust duct 52.

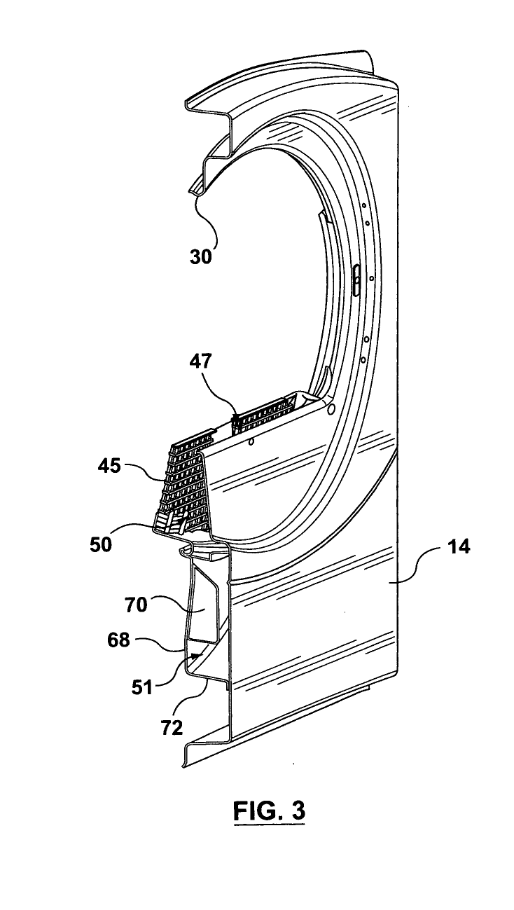

As shown in FIGS. 1 to 3, the trap duct 50 is in air flow communication with the dryer drum 26 through which air flows when leaving the dryer drum. The trap duct 50 in the embodiment shown comprises an inner wall 68 having a side flange 72 mounted to an inside face of the front panel 14. The inner wall 68 comprises the grill 45 having openings for air to flow therethrough. The grill 45 forms a pocket 47 with the front panel 14 for receiving the lint filter 46. The trap duct 50 further comprises a baffle 70 that extends from the inner wall 68 towards the rear face of the front panel 14. The baffle extends parallel to the direction of air flow in the trap duct lower portion 51 and in the embodiment shown, the baffle extends vertically downstream of, or below, the lint filter 46. In the illustrated embodiment, the baffle 70 comprises an elongated fin that is positioned about midway along the width of the filter 46.

It should be understood that in an alternative embodiment where the air flow is not vertical through the trap duct, the baffle may be angled to present minimal restriction to air flow which would be parallel to the air flow. Further, the baffle may be positioned to extend from the rear face of the front panel 14 in an alternative embodiment.

While the invention has been described in terms of various specific embodiments, those skilled in the art will recognize that the invention can be practiced with modifications within the spirit and scope of the present invention as disclosed herein.

What is claimed is:

1. An appliance for drying clothing articles, the appliance comprising:
a drum for receiving the clothing articles;
a motor for rotating the drum about an axis;
a heater for supplying heated air to the drum during a drying cycle;
a trap duct in air flow communication with the dryer drum through which air flows when leaving the dryer drum, the trap duct comprising,
a filter for trapping lint, and
an air flow baffle positioned downstream of the lint filter and extending parallel to direction of air flow through the trap duct.

2. The appliance of claim 2 wherein the baffle extends vertically below the lint trap.

3. The appliance of claim 1 wherein the baffle is positioned midway along the filter.

4. The appliance of claim 3 wherein the baffle is positioned midway along the filter.

5. The appliance of claim 2 wherein the baffle comprises a elongate fin.

6. The appliance of claim 1 further comprising a blower wheel in air flow communication with the trap duct for drawing air from the trap duct and an exhaust duct in air flow communication with the blower wheel for exhausting air from the dryer.

7. The appliance of claim 1 wherein the trap duct comprises an inner wall having a side flange mounted to a front panel of the appliance and wherein the baffle extends from the inner wall towards the front panel.

8. The appliance of claim 7 wherein the inner wall of the trap duct comprises a grill having openings for air to flow therethrough, and the grill forming a pocket with the front panel for receiving the lint filter.
